(19) United States
(12) Patent Application Publication
(10) Pub. No.: US 2023/0271068 A1
(43) Pub. Date: Aug. 31, 2023

(54) PERSONAL SAND TRAP RAKE DEVICE

(71) Applicant: Timothy Talaga, Dekalb, IL (US)

(72) Inventor: Timothy Talaga, Dekalb, IL (US)

(21) Appl. No.: 17/681,764

(22) Filed: Feb. 26, 2022

(51) Int. Cl. A63B 57/50; A01D 7/02

(52) U.S. Cl. CPC A63B 57/50; A01D 7/02

(57) ABSTRACT

A personal sand trap rake is presented. The personal sand trap rake has a rake head that is operable to smooth sand in an area where a golf ball has landed in a bunker on a golf course. The rake head may be adapted to be carried by a golfer or carried on a golf bag. The personal sand trap rake may therefore be available whenever needed without delaying the game to retrieve a full-size rake, without creating a tripping hazard by leaving the full-size rake on the golf course, and without creating an in-play golf obstruction and interference. The rake head may be adapted to be used by hand or may detachably couple to a grip of a golf club thus enabling the golf club to be used as a handle. In some embodiments, the personal sand trap rake may comprise a telescoping handle that may be coupled to the rake head for use as the handle. The personal sand trap rake device is needed to replace the present lack of bunker rakes due to the Covid-19 pandemic.

### FIELD OF THE INVENTION

This invention relates to golf hazards. More particularly, it relates to a device to repair bunkers when a golf ball lands in the bunker.

### BACKGROUND

In the game of golf, bunkers are known to exist. A bunker is a depression near the green or fairway that is usually filled with sand. It is difficult to hit the ball out of the bunker and to enter it is therefore considered punitive to a golfer who misses the target with the previous shot. A club called a “sand wedge” is designed for extracting the ball from a bunker, a process requiring well-developed skill. After a player is done using the bunker, it is the job of either the player or that player's caddie to rake the area of the sand disturbed during play. The rake should reside in proximity to the bunker. Specific rules of golf govern play from a bunker. For example, a player may not ground one's club in a bunker; that is, the club cannot touch the ground before the swing.

There are three types of bunkers used in golf course architecture and all are designed to be impediments to the golfer's progress toward the green. Fairway bunkers are designed primarily to gather up wayward tee shots on par 4 and par 5 holes; they are located to the sides of the fairway or even in the middle of the fairway. Greenside bunkers are designed to collect wayward approach shots on long holes and tee shots on par 3 holes; they are located near and around the green. Waste bunkers are natural sandy areas, usually very large and often found on links courses; they are not considered hazards according to the rules of golf, and so, unlike in fairway or greenside bunkers, golfers are permitted to ground a club lightly in, or remove loose impediments from, the area around the ball.

The bunker rake is a full-sized rake and may not be nearby the bunker when needed. The full size of the rake creates a tripping hazard and may delay the game while retrieving the rake. The bunker rake also creates an in-play golf obstruction and interference. The personal sand trap rake device is needed to replace the present lack of bunker rakes due to the Covid-19 pandemic.

According, and in light of the foregoing, it would be desirable to have a portable device allowing a golfer to rake a sand trap when required to reducing game delays and safety hazards.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of a personal sand trap rake 100, according to an embodiment of the present invention;

FIG. 2 is a front view of a personal sand trap rake 100, according to an embodiment of the present invention;

FIG. 3 is a side view of a personal sand trap rake 100, according to an embodiment of the present invention;

FIG. 4 is a top view of a personal sand trap rake 100, according to an embodiment of the present invention;

FIG. 5 is a bottom view of a personal sand trap rake 100, according to an embodiment of the present invention;

FIG. 6 is an isometric view of a personal sand trap rake 100, according to an alternative embodiment of the present invention;

FIG. 7 is a front view of a personal sand trap rake 100, according to an alternative embodiment of the present invention;

FIG. 8 is a side view of a personal sand trap rake 100, according to an alternative embodiment of the present invention;

FIG. 9 is a top view of a personal sand trap rake 100, according to an alternative embodiment of the present invention;

FIG. 10 is a bottom view of a personal sand trap rake 100, according to an alternative embodiment of the present invention;

FIG. 11 is an isometric view of a personal sand trap rake 100, according to an embodiment of the present invention illustrating insertion of a golf club 910 into the ferrule 210 for use as a handle;

FIG. 12 is an isometric view of a personal sand trap rake 100, according to an embodiment of the present invention illustrating the extended configuration 294 of the telescoping handle 260;

FIG. 13 is an isometric view of a personal sand trap rake 100, according to an embodiment of the present invention illustrating the collapsed configuration 292 of the telescoping handle 260; and,

FIG. 14 is an isometric view of a personal sand trap rake 100, according to an embodiment of the present invention illustrating the telescoping handle 260 inserted into the ferrule 210 of an alternative embodiments of the rake head.

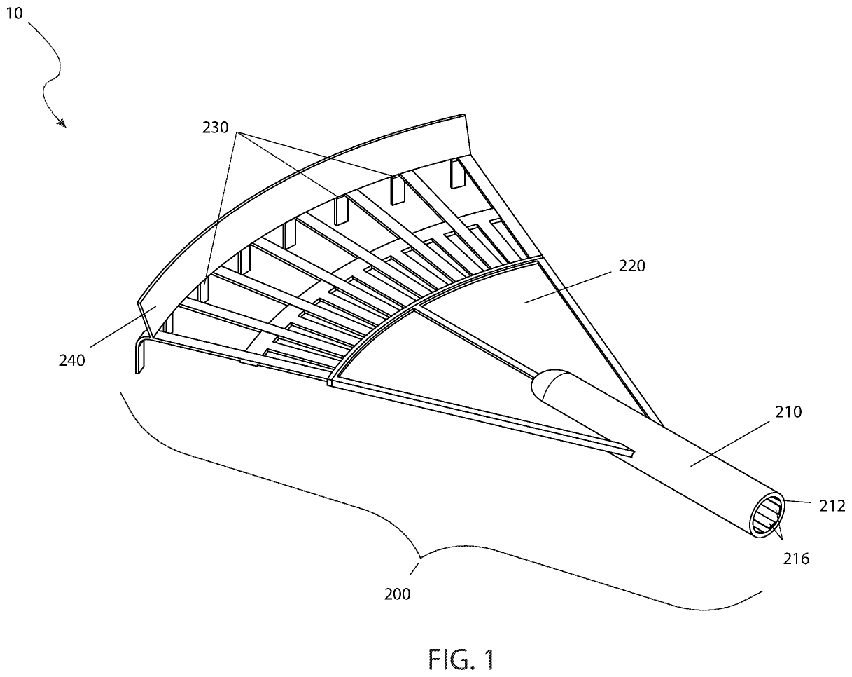

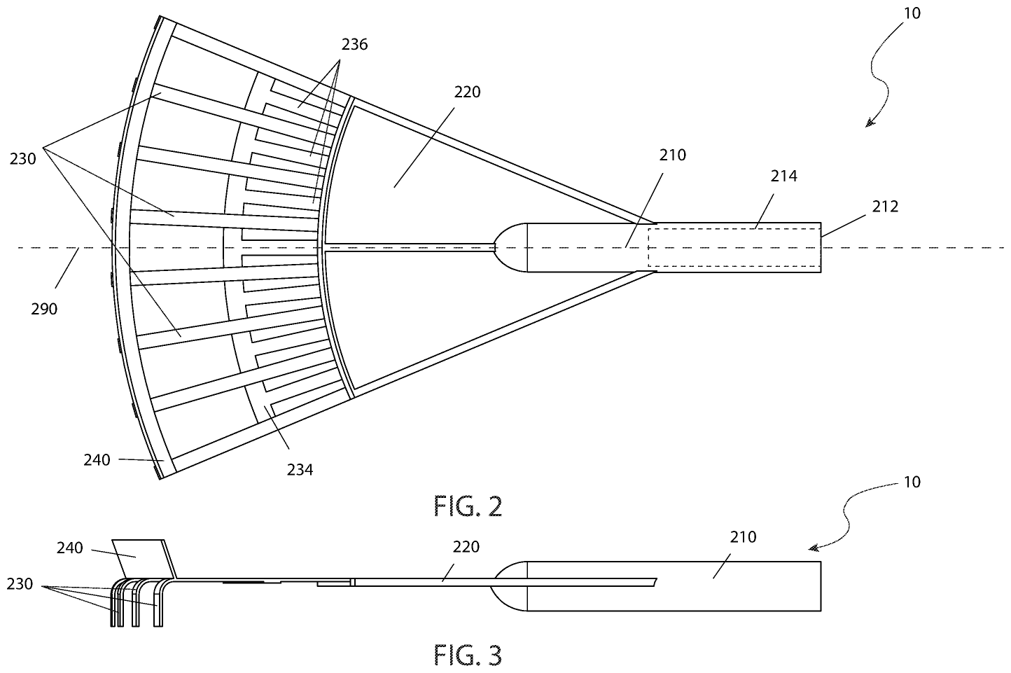

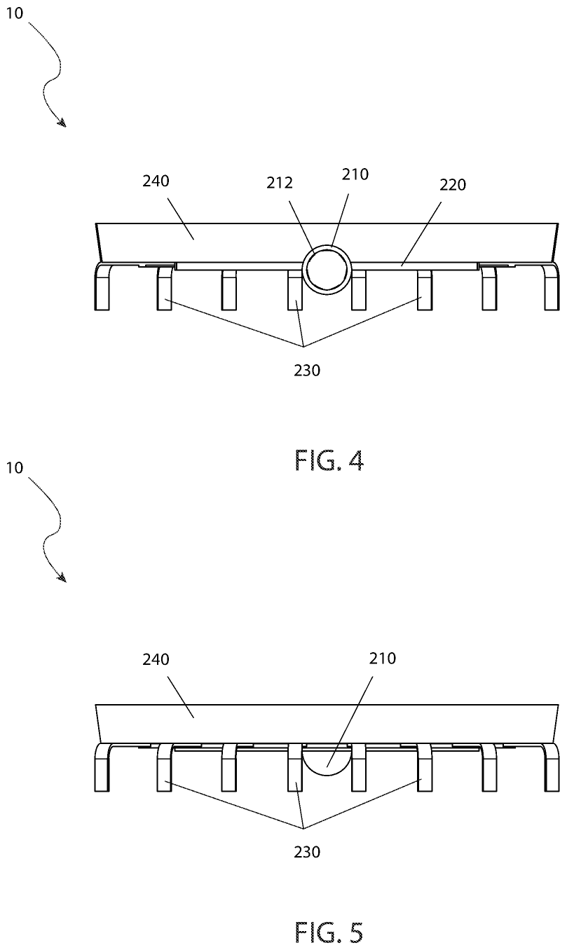

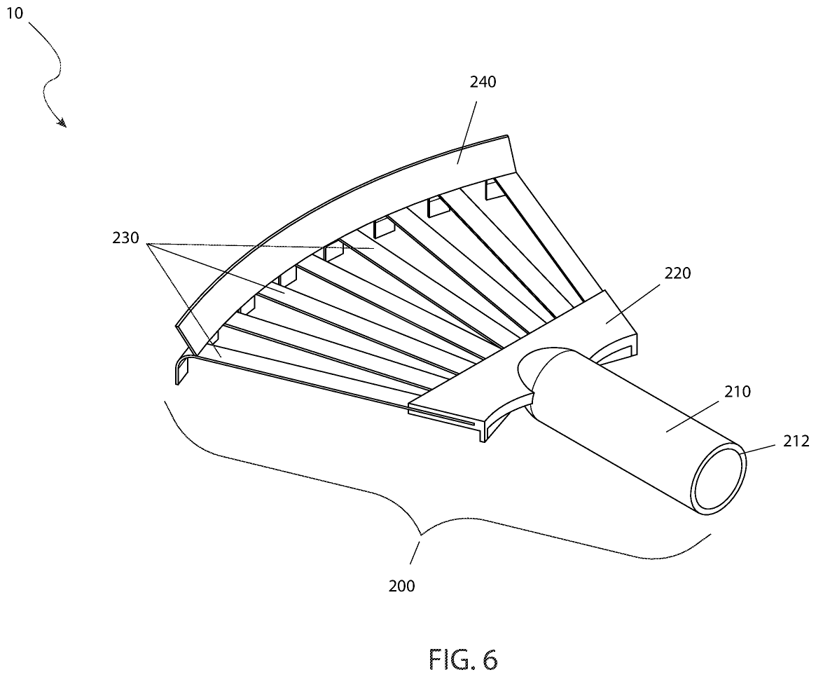

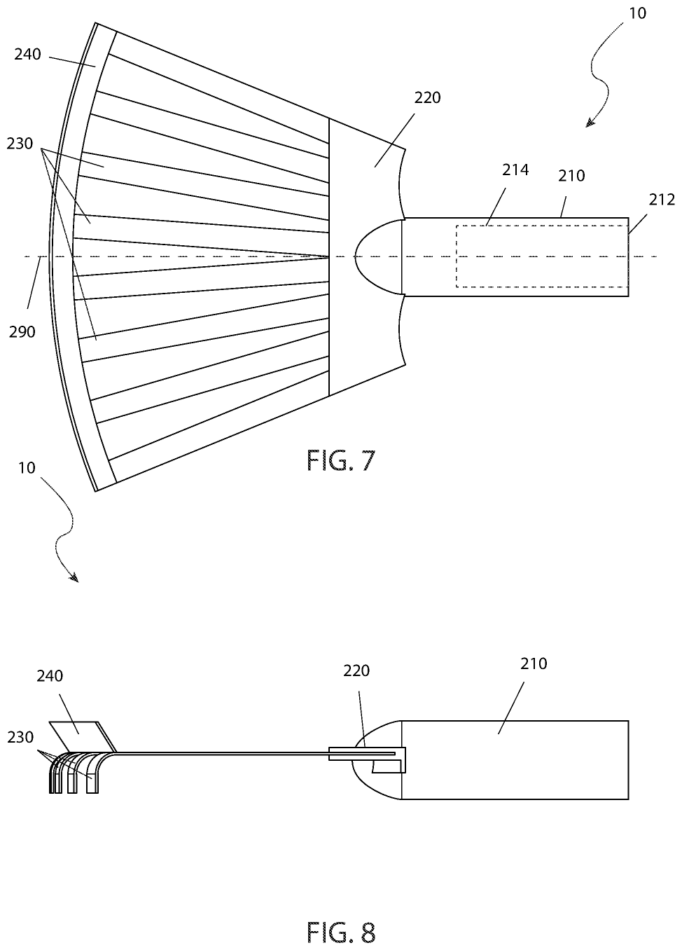

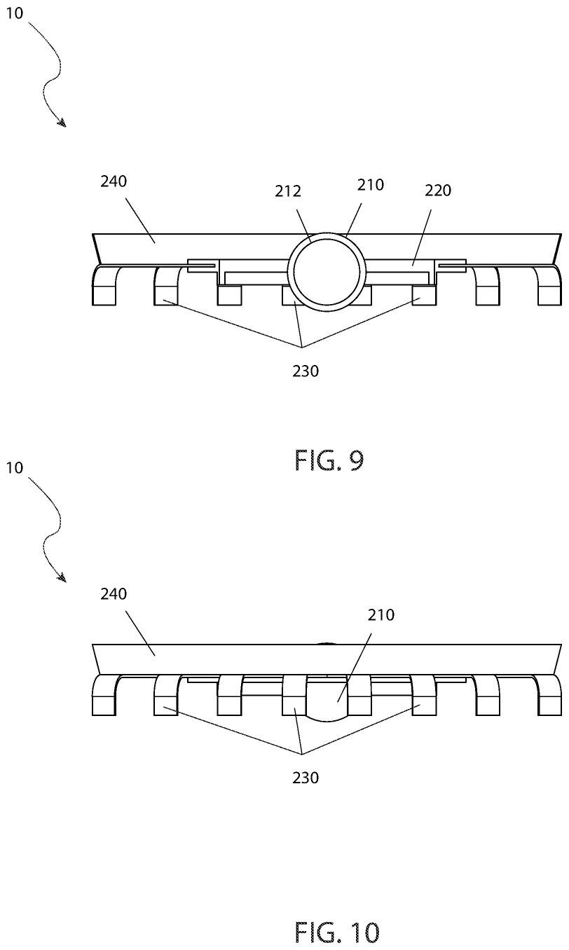

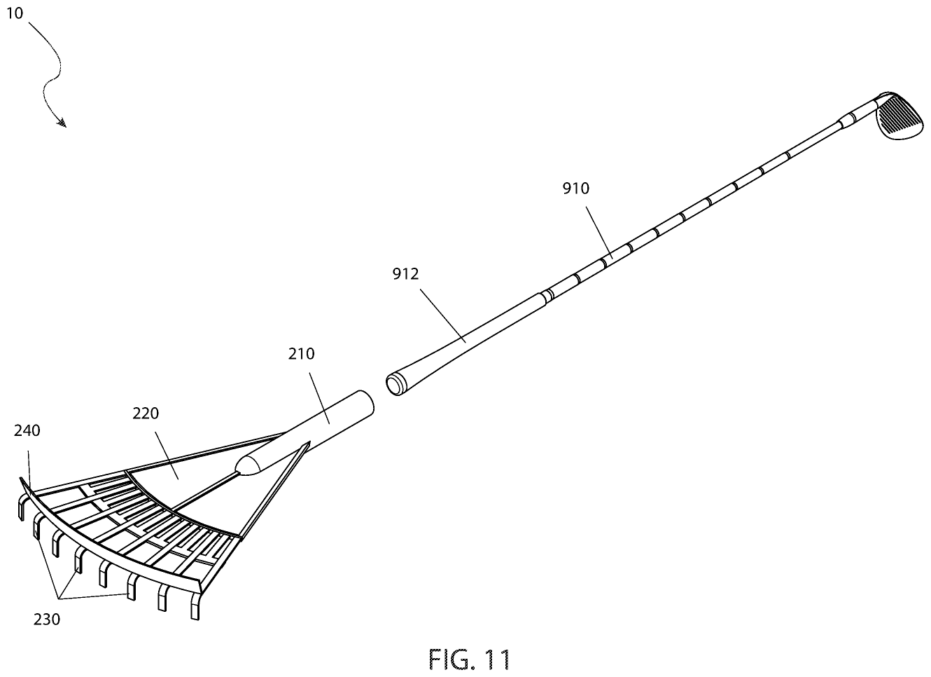

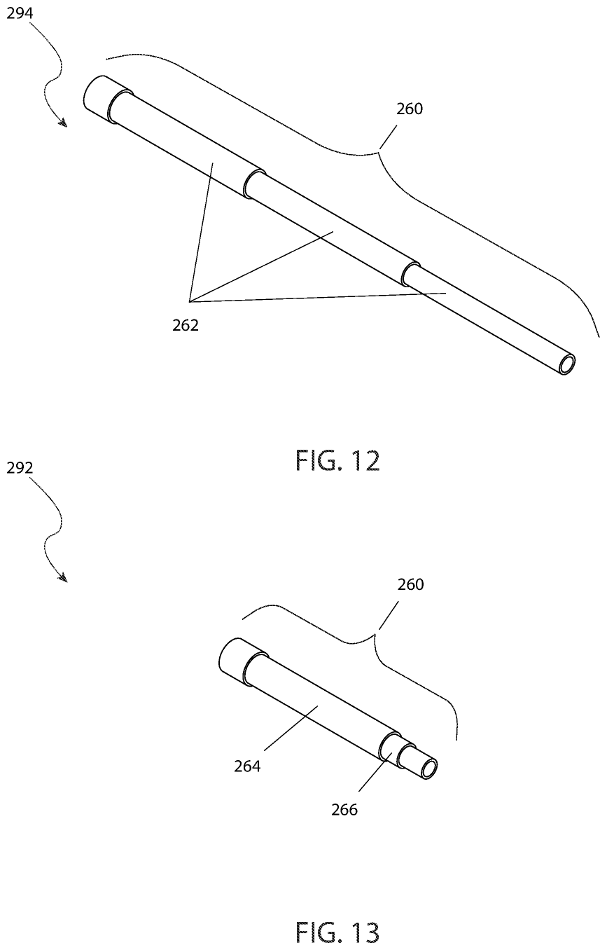

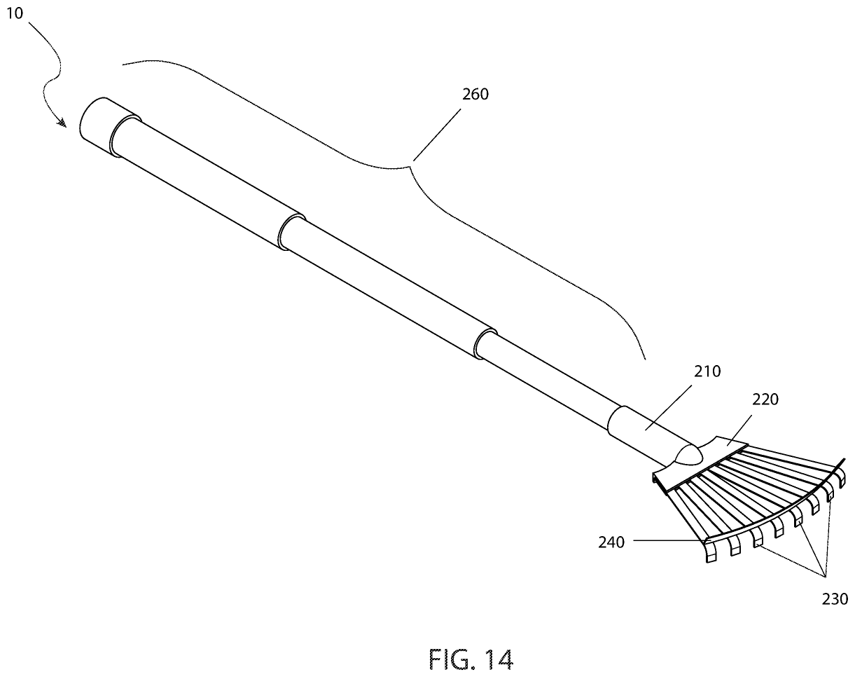

### DESCRIPTIVE KEY

100 personal sand trap rake
200 rake head
210 ferrule
212 handle aperture
214 internal cavity
216 friction liner
220 tine bracket
230 tine
234 lateral stabilizer
236 longitudinal stabilizer
240 smoothing fin
260 telescoping handle
262 telescoping section
264 first section
266 second section
290 longitudinal axis
292 collapsed configuration
294 extended configuration
910 golf club
912 grip

### DESCRIPTION OF THE INVENTION

The present invention is directed to a personal sand trap rake (herein described as the “invention”) 100. The invention 100 may comprise a rake head 200 that is operable to smooth sand in an area where a golf ball has landed in a bunker on a golf course. The rake head 200 may be adapted to be carried by a golfer or carried on a golf bag. The invention 100 may therefore be available whenever needed without delaying the game to retrieve a full size rake and without creating a tripping hazard by leaving the full size rake on the golf course. The rake head 200 may be adapted to be used by hand or may detachably couple to a grip 912 of a golf club 910 thus enabling the golf club 910 to be used as a handle. In some embodiments, the invention 100 may comprise a telescoping handle 260 that may be coupled to the rake head 200 for use as the handle. As a non-limiting example, the bunker may be a sand trap.

The rake head 200 may comprise a ferrule 210, a tine bracket 220, a plurality of tines 230, and a smoothing fin 240. The plurality of tines 230 may be operable to drag the sand as the rake head 200 is pulled over the sand.

The ferrule 210 may be a cylindrical armature located at the top of the rake head 200. The ferrule 210 may comprise an internal cavity 214 that is accessible via a handle aperture 212 located at the top of the ferrule 210. The internal cavity 214 and the handle aperture 212 may have the same diameter. The ferrule 210 may be adapted to be held by the golfer while using the rake head 200. Alternatively, a shaft may be pushed into the internal cavity 214 of the ferrule 210 via the handle aperture 212 such that the shaft may be operable as an extension of the ferrule 210. The golfer may then manipulate the shaft to pull the rake head 200 over the sand.

The diameter of the handle aperture 212 may complement the diameter of the grip 912 of the golf club 910 such that the golf club 910 may be operable as the shaft that extends the ferrule 210 when the grip 912 of the golf club 910 in inserted into the internal cavity 214. In a preferred embodiment, the handle aperture 212 may have a diameter of one and one-sixth inches, with an error of one-sixteenth of an inch (1-1/6+/−1/16 in.). In some embodiments, the internal cavity 214 may comprise one (1) or more friction liners 216 that may be operable to increase friction between the grip 912 of the golf club 910 and the walls of the internal cavity 214. In cases where the diameter of the grip 912 is smaller than the diameter of the internal cavity 214 and friction between the grip 912 and the walls of the internal cavity 214 is insufficient to retain the rake head 200 on the golf club 910, the golfer may jam one (1) or more objects between the grip 912 and the ferrule 210 to tighten the fit of the rake head 200 onto the golf club 910. As a non-limiting example, the objects may be golf tees.

The tine bracket 220 may be coupled to the ferrule 210 and to the plurality of tines 230. The tine bracket 220 may orient the ferrule 210 to align with a longitudinal axis 290 of the invention 100. The tine bracket 220 may orient the plurality of tines 230 such that the plurality of tines 230 lie in a single plane which comprises the longitudinal axis 290. The tine bracket 220 may orient the plurality of tines 230 such that the plurality of tines 230 radiate from a point on the ferrule 210 with equal radial spacing between individual tines. The tine bracket 220 may position the plurality of tines 230 symmetrically with respect to the longitudinal axis 290.

The plurality of tines 230 may be semi-rigid armatures that extend outward from the tine bracket 220. The distal ends of the individual tines may bend rearwards to form an L-shape. During use, the plurality of tines 230 may be pulled over the sand to redistribute the sand. In some embodiments, the tips of the individual tines may align in an arc.

In some embodiments, the rake head 200 may comprise a lateral stabilizer 234. The lateral stabilizer 234 may be a laterally-oriented armature that is coupled to a midpoint of each of the individual tines. In some embodiments, the lateral stabilizer 234 may be bowed.

In some embodiments, the rake head 200 may comprise a plurality of longitudinal stabilizers 236. The plurality of longitudinal stabilizers 236 may be dispersed between the individual tines. One (1) end of an individual longitudinal stabilizer selected from the plurality of longitudinal stabilizers 236 may be coupled to the lateral stabilizer 234 and the opposite end of the individual longitudinal stabilizer may be coupled to the tine bracket 220.

The smoothing fin 240 may be a laterally-oriented panel that projects from the front of the rake head 200. The smoothing fin 240 may be coupled to the plurality of tines 230. In some embodiments, the smoothing fin 240 may be coupled directly over the forward leading upper edge of the plurality of tines 230. The smoothing fin 240 may be operable to smooth the sand when the rake head 200 is turned upside down with the smoothing fin 240 against the sand and the plurality of tines 230 pointing upwards and the smoothing fin 240 is pulled over the sand.

An alternative embodiment may reduce the size of the rake head 200 such that the rake head 200 is more compact and therefore easier to carry in a pocket and easier to use. In the alternative embodiment, the ferrule 210 may be shorter, the tine bracket 220 may be shorter, the plurality of tines 230 may be shorter, the lateral stabilizer 234 may be eliminated, the plurality of longitudinal stabilizers 236 may be eliminated, or combinations thereof.

In some embodiments, the invention 100 may comprise the telescoping handle 260 that may detachably couple to the rake head 200. The telescoping handle 260 may be carried separately and coupled to the rake head 200 when needed, such that the rake head 200 may be used by hand or may be coupled to the telescoping handle 260. The telescoping handle 260 may comprise a plurality of telescoping sections 262 that may extend and collapse by sliding the plurality of telescoping sections 262 in and out of each other. As a non-limiting example, a first section 264 and a second section 266 selected from the plurality of telescoping sections 262 may be adjacent and the first section 264 may comprise an inside diameter that is larger than an outside diameter of the second section 266 such that the second section 266 may slide in and out of the first section 264. In a collapsed configuration 292, the plurality of telescoping sections 262 may all be pushed into adjacent sections such that the telescoping handle 260 takes up minimal space. In an extended configuration 294, the plurality of telescoping sections 262 may all be pulled out of the adjacent sections such that the telescoping handle 260 reaches a maximum length.

In some embodiments, the telescoping handle 260 may be prevented from extending or collapsing during use by a friction fit between adjacent sections. An external force that exceeds a predefined force threshold may overcome the friction between the adjacent sections, permitting the telescoping handle 260 to extend or collapse.

In some embodiments, the telescoping handle 260 may be prevented from extending or collapsing during use by a twist-lock brake within each of the plurality of telescoping sections 262. Twisting an individual section 262 in a first rotational direction around the longitudinal axis of the telescoping handle 260 may lock the individual section to an adjacent section and may prevent extending or collapsing the individual section 262. Twisting the individual section 262 in a second rotational direction that is opposite the first rotational direction may unlock the individual section 262 and may permit extending or collapsing the individual section 262.

In use, the rake head 200 may be carried onto the golf course for use when a golf ball lands in a bunker. As non-limiting examples, the rake head 200 may be carried in the golfer's pocket or attached to the golf bag. When the golfer hits the golf ball into the bunker, the golfer may use the plurality of tines 230 of the rake head 200 to redistribute the sand surrounding the golf ball and/or may use the smoothing fin 240 to smooth the sand before replacing the golf ball. Removing ridges and clumps of sand may improve the chances of a clean shot out of the bunker. The golfer may grasp the ferrule 210 of the rake head 200 to use the rake head 200 by hand or the golfer may couple the rake head 200 to the golf club 910 or to the telescoping handle 260 so that the golfer may use the rake head 200 from a standing or crouching position.

The exact specifications, materials used, and method of use of the invention 100 may vary upon manufacturing. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A personal sand trap rake device for smoothing sand after a golf ball has landed in a bunker on a golf course, the device comprising:
a rake head, the rake head comprising:
a ferrule the ferrule having a top, the top of the ferrule having an internal cavity, the internal cavity being accessible via a handle aperture at the top of the ferrule;
a plurality of tines, the plurality of times being configured to drag sand as the rake head is pulled over the same;
a tine bracket, the time bracket being coupled to the ferrule and to each of the plurality of tines, wherein the tine bracket configured to align the ferrule with a longitudinal axis of the device; and
a smoothing fin.

2. The device according to claim 1, wherein the rake head is adapted to be used by hand.

3. The device according to claim 1, wherein the rake head being coupled attachable to a grip of a golf club.

4. The device according to claim 3, wherein the diameter of the handle aperture being the same as the diameter of the grip of the golf club.

5. The device according to claim 3, wherein the device further comprises one or more friction liners, the friction liners being for increasing the friction between the grip of the golf club and the internal cavity.

6. The device according to claim 1, wherein the rake head being coupled to a handle.

7. The device according to claim 6, wherein the handle being telescopic.

8. The device according to claim 6, wherein the internal cavity and the handle having the same diameter.

9. The device according to claim 1, wherein the ferrule is a cylindrical armature at the top of the rake head.

10. The device according to claim 1, wherein the handle having a diameter of between one and one-sixth inches (1⅙″) plus or minus one sixteenth inches (+− 1/16″).

11. The device according to claim 1, wherein the tine bracket configured to position the tines to radiate from a point on the ferrule with equal radial spacing between the tines.

12. The device according to claim 1, wherein the tine bracket being configured to orient the tines symmetrically with respect to the longitudinal axis.

13. The device according to claim 1, wherein the tines are semi-rigid.

14. The device according to claim 13, wherein the tines extend outward from the tine bracket.

15. The device according to claim 1, wherein a distal end of each of the tines be bent rearwards to for an L-shape.

16. The device according to claim 1, wherein the rake head further comprises a lateral stabilizer.

17. The device according to claim 16, wherein the lateral stabilizer being configured to be laterally oriented armature coupled to a midpoint of each of the tines.

18. The device according to claim 16, wherein the lateral stabilizer being bowed.

19. The device according to claim 1, wherein the smoothing fin is configured to be laterally-oriented panel projecting from a front of the rake head.

20. The device according to claim 19, wherein the smoothing fin being coupled to a forward leading upper edge of each of the tines.
